(19) United States
(12) Patent Application Publication
(10) Pub. No.: US 2008/0279424 A1
(43) Pub. Date: Nov. 13, 2008

(54) Method of Identifying Faces from Face Images and Corresponding Device and Computer Program

(75) Inventors: Sid Ahmed Berrani, Rennes (FR); Christophe Garcia, Rennes (FR)

Correspondence Address: WESTMAN CHAMPLIN & KELLY, P.A., SUITE 1400, 900 SECOND AVENUE SOUTH, MINNEAPOLIS, MN, 55402-3244, US

(73) Assignee: France Telecom, Rennes (FR)

(21) Appl. No.: 11/910,158

(22) PCT Filed: Mar. 28, 2006
(86) PCT No.: PCT/EP2006/061109

§ 371 Date: Jun. 2, 2008

(30) Foreign Application Priority Data
Mar. 29, 2005 (FR) 0503047

(51) Int. Cl. G06K 9/80

(52) U.S. Cl. 382/118

(57) ABSTRACT

A method identifying faces from facial images called query images, associated with at least one person, including a learning phase using learning images and a recognition phase used to identify the faces appearing in query images. The learning phase includes filtering the images, applied on the basis of a group of at least two learning facial images associated with the at least one person, enabling selection of at least one learning image representing the face to be identified. The recognition phase uses only the learning images selected during the learning phase. Filtering is performed using at least one of the thresholds belonging to the group including: a maximum distance taking at least account of the membership of the vectors in a cloud constituted by the vectors; and a maximum distance between the vectors and vectors rebuilt after projection of the vectors on a space associated with said cloud of vectors.

### CROSS-REFERENCE TO RELATED APPLICATION

This application is a Section 371 National Stage Application of International Application No. PCT/EP2006/061109, filed Mar. 28, 2006 and published as WO 2006/103240 A1 on Oct. 5, 2006, not in English.

### FIELD OF THE DISCLOSURE

The field of the disclosure is that of the processing of images and image sequences, such as video sequences. More specifically, the disclosure relates to a technique for the recognition of faces from a set of facial images of one or more persons.

The disclosure can be applied especially but not exclusively in the fields of biometrics, video surveillance or video indexing in which it is important to recognize a face from a still image or a video sequence (for example to authorize a recognized person to obtain access to a protected place).

### BACKGROUND

There are several techniques to date for face recognition from sequences of still or moving images. These techniques rely classically on a first learning phase in which a learning base is built, out of facial images of different persons (possibly extracted from learning video sequences) and on a second phase of recognition during which the images of the learning base are used to recognize a person.

Theses techniques generally use statistical methods for the computation, on the basis of the learning base, of a description space in which the similarity between two faces is evaluated. The goal then is to express the notion of resemblance between two faces as faithfully as possible in a simple notion of spatial proximity between the projections of faces in the description space.

The main differences between the different existing techniques lie in the processing performed during the recognition phase.

Thus, A. W. Senior in “Recognizing Faces in Broadcast Video”, Proc. of Int. Workshop on Recognition, Analysis and Tracking of Faces and Gestures in Real Time Systems, Corfu, Greece, September 1999, pp. 105-110, proposes the use, during the recognition phase, of either all the facial images extracted from a video sequence or a single key facial image, namely the one to which the face detector has assigned the highest confidence score.

In another approach, A. Hadid, and M. Pietikäinen in “From Still Image to Video-Based Face Recognition: An Experimental Analysis”, Proc. of 6^{th} Int. Conf. on Automatic Face and Gesture Recognition, Seoul, Korea, May 2004, pp. 813-818, for their part propose the selection of key images from the video sequence without analyzing the faces that they contain, and then the performance of the recognition in considering solely the faces extracted from the key images. Since each face returns a different result, a classic procedure of merger of the results, done a posteriori, is then used.

Finally, E. Acosta and al, for their part, in “An Automatic Face Detection and Recognition System for Video Indexing Applications” Proc. of the Int. Conf. on Acoustic Speech and Signal Processing (vol. 4), Orlando, Fla., May 2002, pp. IV-3644-IV-3647, use all the faces extracted from the query video sequence during the recognition. To evaluate the proximity between the request and the model of one of the persons stored in the learning base, a measurement of similarity is computed between each face image extracted from the query sequence and the model. The final value of the similarity is the median value of all the measurements computed, and this amounts to considering only one face image from among all those that had been extracted.

These different techniques of the prior art all rely on statistical methods enabling the building of a description space in which facial images are projected. Now these projections must be capable of absorbing the variations that may affect the facial images, i.e. they must be capable of highlighting the resemblances between facial images despite variations that may affect the images.

These variations may be of two types. There are first of all variations inherent in changes in facial expression (for example in smiling) and forms of concealment (e.g. wearing glasses, a beard etc). Then, there are variations due to the conditions of acquisition of the image (e.g. lighting conditions) and to the segmentation of the face (i.e. extraction and centering of the image portion containing the face).

While the prior art methods for the recognition of faces are efficient when the facial images are well framed and taken in good lighting conditions, their performance deteriorates sharply when the facial images used for learning or during recognition are not very well aligned (i.e. the different attributes of the faces, the eyes, the mouth, the nose etc. are not in the same place in all the facial images) and/or are not of good quality.

Now, in the context of facial recognition from video sequences, these conditions of alignment and high quality of the images of faces are generally not verified. On the one hand, the acquisition of the sequences is not subjected to very great constraint and the person to be recognized does not generally remain in a frontal position facing the camera throughout the acquisition time. Secondly, the facial images are extracted automatically from video sequences by means of face detection techniques, which may generate false detections and are imprecise in terms of framing. The images of faces used in the context may therefore be of poor quality and badly framed and may contain poor detections.

The inventors of the present patent application have therefore identified the fact that one of the major drawbacks of existing methods for the recognition of faces from video sequences lies in the fact that the quality of the facial images used is not taken into account.

Thus, for example, all the facial images available (for example all the facial images extracted from video sequences) are routinely taken into account during the learning stage. This considerably reduces the performance of these techniques because the statistical methods (of the PCA or principal component analysis type) used for face recognition are extremely sensitive to noise because they rely on the computation of a covariance matrix (i.e. first and second order moments).

Similarly, according to these prior art methods, the choice of the facial images used during the recognition phase is not optimal. Now, the choice of these images strongly influences the performance of these face recognition techniques: they have to be well framed and of good quality. However, none of the prior art methods referred to here above proposes a mode of selection of the images that takes account of their “quality”.

### SUMMARY

An embodiment of the invention relates to a method of identification of at least one face from a group of at least two facial images associated with at least one person, said method comprising a phase of learning and a phase of recognition of said at least one face.

According to an embodiment of the invention, the learning phase comprises at least one first step of filtering said images, using a group of at least two learning facial images associated with said at least one person, enabling the selection of at least one learning image representing said face to be identified, the recognition phase using solely said learning images selected during the learning phase. The filtering is done using at least one of the thresholds belonging to the group comprising:
a maximum distance (DRCₘₐₓ) taking at least account of the membership of vectors associated with at least certain of said images in a cloud constituted by said vectors;
a maximum distance (DOₘₐₓ) between said vectors and vectors rebuilt after projection of said vectors on a space associated with said cloud of vectors.

Thus, an embodiment of the invention relies on a wholly novel and inventive approach to face recognition from still images or images extracted from video sequences. Indeed, an embodiment of the invention proposes not to take account of the set of available facial images to identify the face of a person but to carry out a filtering of the images in order to select solely good-quality images, i.e. images representative of the face to be identified (because the face is in a frontal pose, or is well framed etc). This filtering is done by means of one or two filtering thresholds which are robust distance to the center or DRC and/or the orthogonal distance or DD. A filtering of this kind is done on the vectors associated with the images and, after analysis of the distribution and statistical properties of these vectors, enables the detection and isolation of the aberrant vector or vectors. It is based on the assumption that the majority of the images available are good-quality images. This enables the identification of all the vectors that do not follow the properties of distribution of the set of vectors available as aberrant vectors and are therefore associated with lower-quality images or in any case are poorly representative of the face to be identified.

The robust distance to the center or DRC takes account of the distance of a vector from the center of the cloud of vectors and the membership of the vector considered in this cloud. The orthogonal distance or DD is the distance between a vector and the vector obtained after projection of the original vector in a space associated with the cloud of vectors followed by inverse projection.

Thus, unlike in the methods of the prior art in which all the available images were systematically taken into account during the learning process, an embodiment of the invention proposes the selection only of a part of the learning images as a function of their quality so as to keep only those that are the most representative of facial images.

According to a first advantageous characteristic of an embodiment of the invention, at least one of said thresholds is determined from vectors associated with said learning images.

Advantageously, said learning phase also comprises a step of building a vector space of description of said at least one person from said representative learning image or images. This building step uses a technique belonging to the group comprising:
a Principal Component Analysis technique;
a Linear Discriminant Analysis technique;
a 2D Principal Component Analysis technique;
a 2D Linear Discriminant Analysis technique.

In a second advantageous characteristic of an embodiment of the invention, said recognition phase implements a second filtering step, from a group of at least two facial images associated with said at least one person, called query images, and enables the selection of at least one query image representing said face to be identified, and at least one of said thresholds being determined during said learning phase from vectors associated with learning facial images.

Thus, the query images are filtered as a function of their quality so as to carry out the recognition only on the basis of the least noisy and most representative faces. Thus, facial identification performance is considerably improved as compared with performance in prior art techniques. This second filtering done during the recognition phase is thus complementary to the first filtering done during the learning phase. Furthermore, it is particularly advantageous to use the thresholds computed during the learning phase because the learning images are generally of higher quality than the query images owing to their conditions of acquisition.

In one variant of an embodiment of the invention, at least one of said thresholds is determined during said recognition phase, using vectors associated with a set of images comprising at least two facial images associated with said at least one person, called query images and at least two learning images representing said face to be identified, selected during said learning phase, and said recognition phase implements a second filtering step, using said query images, and enables the selection of at least one query image representative of said face to be identified.

Thus, both the least noisy learning images and the least noisy query images are selected, greatly improving face recognition performance as compared with the prior art techniques.

In this variant, filtering is carried out also on the query images during the recognition phase in using the results of the learning phase but this time in the form of learning images representing the face or faces to be identified and no longer in the form of thresholds.

Preferably, said recognition phase also includes a step of comparison of projections, in a vector space of description of said at least one person built during said learning phase, of vectors associated with said at least one representative query image and with at least one representative learning image selected during said learning phase so as to identify said face. The notion of resemblance between two faces is then expressed as a simple notion of spatial proximity between the projections of the faces in the description space.

During this comparison step:
the projection of each of said vectors associated with each of said representative query images is compared with the projection of each of said vectors associated with each of said representative learning images;
for each of said vectors associated with each of said representative query images, the closest vector associated with one of said representative learning images and the person, called a designated person, with whom it is associated are determined;
said face is identified as being that of the person designated the greatest number of times.

Preferably, said first step of filtering said learning images and/or said second step of filtering said query images apply said two thresholds, namely DOₘₐₓ and DRCₘₐₓ (computed for all the images or sequence by sequence).

For a preferred application of an embodiment of the invention, at least certain of said images are extracted from at least one video sequence by implementation of a face detection algorithm well known to those skilled in the art.

The identification method of an embodiment of the invention also comprises a step of resizing said images so that said images are all of the same size. More specifically, in the presence of an image or a video sequence, a face detector enables the extraction of a facial image of a fixed size (all the images coming from the detector are thus of a same size). Then, during the processing of this facial image of a fixed size, a first resizing is performed on the image during the filtering of the learning phase so as to reduce its size. This averts the need to take account of the details and removes the noise (for example, only one in every three pixels of the original image is kept). A second resizing of the image is also done during the building of the description space.

Advantageously, said vectors associated with said images are obtained by concatenation of rows and/or columns of said images.

According to a first advantageous variant of an embodiment of the invention, said learning phase being implemented for learning images associated with at least two persons, said thresholds associated with the learning images of each of said at least two persons are determined and, during said recognition phase, said query images are filtered from said threshold associated with each of said at least two persons. There are as many thresholds DO^{(j)}ₘₐₓ and DRC^{(j)}ₘₐₓ computed as there are persons j in the learning base.

According to a second advantageous variant of an embodiment of the invention, said learning phase being implemented for learning images associated with at least two persons, said thresholds associated with the learning images of the set of said at least two persons are determined and, during said recognition phase, said query images are filtered from said threshold associated with the set of said at least two persons. Then, only two thresholds DOₘₐₓ and DRCₘₐₓ are computed for the set of persons of the learning base.

According to an advantageous characteristic of an embodiment of the invention, said thresholds DOₘₐₓ and DRCₘₐₓ are determined at the end of a Robust Principal Component Analysis (RobPCA) applied to said vectors associated with said learning images, enabling the determining also of a robust mean μ associated with said vectors, and a projection matrix P built from eigen vectors of a robust covariance matrix associated with said vectors,

and said thresholds are associated with the following distances:

$${DO}_{i} = ‖ {x}_{i} - μ - {P}_{d , k} {y}_{i}^{t} ‖$$

$${DRC}_{i} = \sqrt{{\sum }_{j = 1}^{k} \frac{{y}_{ij}^{2}}{{l}_{j}}}$$

where xᵢ is one of said vectors associated with said learning images,
P_{d,k} is the matrix comprising the k first columns of said projection matrix P,
yᵢⱼ is the j^{th} element of a projection yᵢ of said vector xᵢ from said projection matrix and from said robust mean.

The values of DOₘₐₓ and DRCₘₐₓ are determined by analysis of the distribution of the values of DOᵢ and DRCᵢ for the set of vectors xᵢ.

It will be noted that, throughout this document, the following notations are used:
the letters in upper case (e.g. A, B) referred to matrices for which the number of rows and the number of columns are mentioned as needed as indices (e.g. A_{n,m} is thus a matrix with n rows, m columns);
letters in lower case (e.g. a, b) refer to vectors;
for a matrix A_{n,m}, aᵢ refers to the i^{th} row of A and aᵢⱼ refers to the element situated at the intersection of the i^{th} row and the j^{th} column of A;
det(A) is the determinant of the matrix A;
lₙ is the unit vector with a dimension n;
diag(a₁, . . . , aₙ) is the diagonal matrix with n rows, n columns, for which the elements of the diagonal are a₁, . . . , aₙ;
A^{t} is the transposed matrix of the matrix A;
a^{t} is the transpose of the vector a;
∥v∥ is the Euclidean norm of the vector v.

The an embodiment of invention also pertains to a system for the identification of at least one face from a group of at least two facial images associated with at least one person, said system comprising a learning device and a device for the recognition of said at least one face.

In such a system, the learning device comprises means for determining at least one of the thresholds belonging to the group comprising:
a maximum distance (DRCₘₐₓ) taking at least account of the membership of vectors associated with at least certain of said images in a cloud constituted by said vectors;
a maximum distance (DOₘₐₓ) between said vectors and vectors rebuilt after projection of said vectors on a space associated with said cloud of vectors.
   and first means of filtering said images, using a group of at least two learning facial images associated with said at least one person, enabling the selection of at least one learning image representing said face to be identified from at least one of said thresholds,
   the recognition device using solely said learning images selected by said learning device.

An embodiment of the invention also pertains to a learning device of a system for the identification of at least one face from a group of at least two facial images associated with at least one person.

Such a device comprises:

means of analysis of said learning images that make it possible, using vectors associated with said learning images, to determine at least one of the thresholds belonging to the group comprising:
a maximum distance (DRCₘₐₓ) taking at least account of the membership of said vectors in a cloud constituted by said vectors;
a maximum distance (DOₘₐₓ) between said vectors and vectors rebuilt after projection of said vectors on a space associated with said cloud of vectors;

first means of filtering said learning images, using at least one of said thresholds, so as to select at least one learning image representing said face to be identified;

means of building a vector space of description of said at least one person from said representative learning image or images,

so that only said learning images selected by said learning device are used by a recognition device.

An embodiment of the invention also pertains to a device for the recognition of at least one face from a group of at least two facial images associated with at least one person, called query images, said recognition device belonging to a system of identification of said at least one face also comprising a learning device.

A recognition device of this kind comprises:
second means of filtering said query images, using at least one threshold determined by said learning device, so as to select at least one query image representing said face to be recognized;
means of comparison of projections, in a vector space of description of said at least one person built by said learning device, of vectors associated with said at least one representative query image and with at least one representative learning image selected by said learning device, so as to identify said face,
   said learning device comprising first filtering means implemented from a group of at least two learning facial images associated with said at least one person enabling the selection of at least one representative learning image of said face to be identified, said recognition device using only said learning images selected by said learning device.

An embodiment of the invention also relates to a computer program comprising program code instructions for the execution of the learning phase of the method of identification of at least one face described here above when said program is executed by a processor.

An embodiment of the invention finally concerns a computer program comprising program code instructions for the execution of the steps of the phase of recognition of the method of identification of at least one face described here above when said program is executed by a processor.

Other features and advantages shall appear more clearly from the following description of a preferred embodiment, given by way of a simple illustrative and non-restrictive example and from the appended drawings.

### BRIEF DESCRIPTION OF THE DRAWINGS

FIG. 1 presents an example of facial images in a frontal pose and well framed;

FIG. 2 presents an example of facial images which, contrary to those of FIG. 1, are noisy because they are poorly framed and/or in a non-frontal pose;

FIG. 3 is a block diagram of the face identification method of an embodiment of the invention;

FIG. 4 provides a more precise illustration of the processing operations performed during the learning phase of the method of FIG. 3, in a particular embodiment of the invention;

FIG. 5 provides a more schematic view of the learning phase of FIG. 4;

FIG. 6 is a more detailed illustration of the processing operations performed during the recognition phase of the method illustrated in FIG. 3;

FIGS. 7 and 8 respectively present simplified drawings of the learning and face recognition devices of an embodiment of the invention.

### DETAILED DESCRIPTION OF ILLUSTRATIVE EMBODIMENTS

The general principle of an embodiment of the invention relies on the selection of a subset of images to be used during the learning phase and/or the recognition phase, by the use of a Robust Principal Component Analysis or RobPCA. An embodiment of the invention can be used for example to isolate the noisy images of faces during the learning and to deduce parameters enabling the filtering also of the facial images during the recognition. This enables a description space to be rebuilt without taking account of the noise and the recognition to be done on the basis of several examples of facial images that are also non-noisy. The proposed approach thus enables a considerable increase in the recognition rates as compared with an approach that would take account of all the images of the sequence.

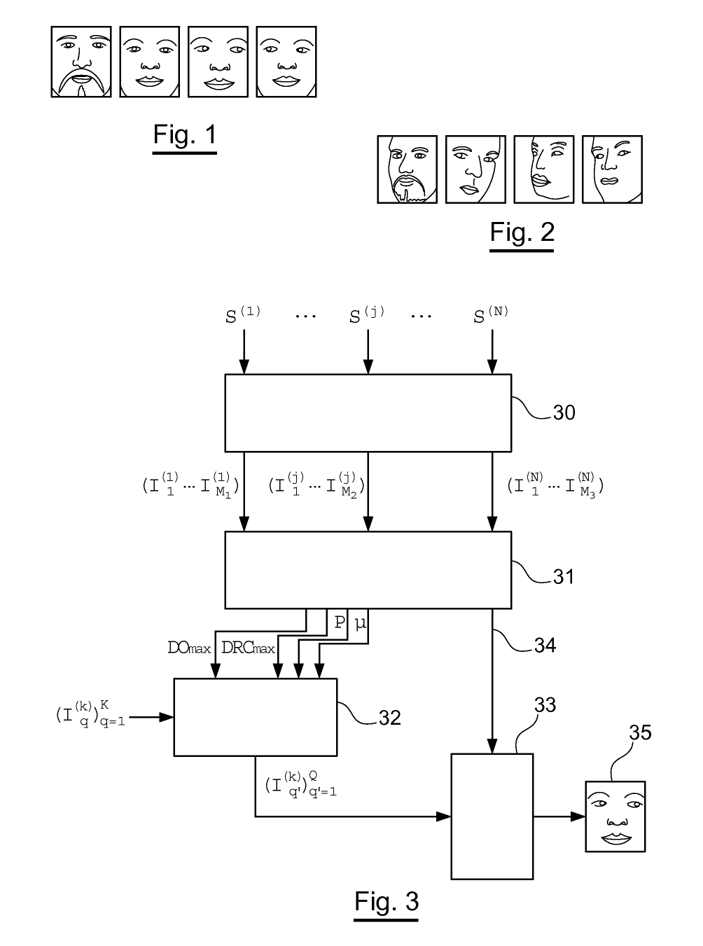

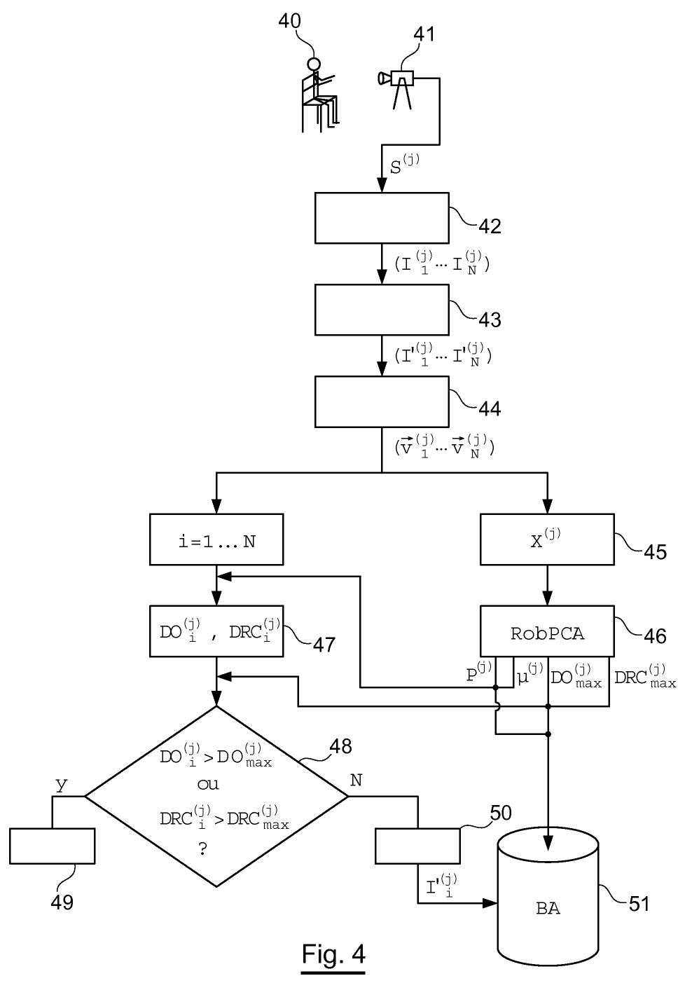

Referring to FIGS. 1 and 2, examples of facial images are presented, some in a frontal pose and well-framed (FIG. 1) and some in a non-frontal pose and poorly framed and therefore noisy (FIG. 2). An embodiment of the invention therefore enables the selection, in the presence of a set of facial images, of only facial images of the FIG. 1 type of images to perform the learning or recognition of faces and the setting aside of all the facial images of the FIG. 2 type of images which are considered to be noisy images.

We shall strive, throughout the rest of the document, to describe an example of an embodiment of the invention in the context of the recognition of faces from video sequences both during the learning phase and during the recognition phase. An embodiment of the invention can be applied, naturally, also to the recognition of facial images from a set of still images obtained for example by means of a camera in burst mode.

Furthermore, we shall strive to describe a particular embodiment in which the noisy images are filtered both during the learning phase and during the recognition phase, in which the results of the learning phase are used. These two phases may of course also be implemented independently of each other.

FIG. 3 is a block diagram of the face identification method of an embodiment of the invention, which comprises three main steps:
analysis 31 of the corpus of the facial images ((I₁⁽¹⁾, . . . I_{M1}⁽¹⁾), (I₁⁽ⁱ⁾, . . . I_{M2}^{(j)}), . . . (I₁⁽ⁿ⁾, . . . I_{M3}^{(N)})) extracted (30) from the learning video sequences (S⁽¹⁾, . . . S^{(j)}), . . . S^{(N)}, where the index j designates the person with whom the sequence (S^{(j)}) is associated) to determine, firstly, two decision thresholds (DOₘₐₓ, DRCₘₐₓ) to filter the non-representative facial images and, secondly, a model 34 (a description space) based on the representative facial images;
filtering 32 of the facial images to be recognized (I_{q}^{(k)})_{q=1}^{K} (images extracted from the query sequence) according to the thresholds (DOₘₐₓ, DRCₘₐₓ) obtained during the learning phase to obtain representative facial images according to these criteria (I_{q}^{(k)})_{q′=1}^{Q}. As described in greater detail here below in the document, this filtering also takes account of a projection matrix P and of a robust mean μ;
use solely of the representative facial images (I_{q′}^{(k)})_{q′=1}^{Q} for the recognition 33 of faces 35 according to the model 34 obtained during the learning phase.

It is of course possible, although infrequent, that no image is of a quality good enough to be kept as a representative image during the filtering. It is then necessary to select at least one image, according to a criterion to be defined: for example it can be chosen to select the first image of the sequence.

Here below, these different main steps are presented in greater detail.

### 1.1 Analysis of the Learning Video Sequences and Selection of the Representative Images

Each person 40 (also identified by the index j) has an associated video sequence S^{(j)}. A sequence S^{(j)} may be acquired in filming the person 40 by means of a camera 41 for a determined duration. By the application of a face detector 42 to each of the images of the sequence S^{(j)} (according to a technique well known to those skilled in the art which is not an object of an embodiment of the present invention and shall therefore not be described in greater detail), a set of facial images (I₁^{(j)}, . . . I_{N}^{(j)}), is extracted from the sequence S^{(j)}. An embodiment of the invention then enables the selection solely of the facial images that are in a frontal position and are well framed, and this is done in analyzing the images of the faces themselves. To this end, an embodiment of the invention uses a robust principal component analysis (RobPCA), as described by M. Hubert, P. J. Rousseeuw, and K. Vanden Branden in “ROBPCA: A New Approach to Robust Principal Component Analysis”, Technometrics, 47(1): 64-79 Feb. 2005.

The idea here is to consider each of the facial images Iᵢ^{(j)} as a vector vᵢ^{(j)} and liken the problem to a problem of detection of aberrant vectors, in assuming that the majority of the faces extracted from the sequence S^{(j)} are of good quality (i.e. well framed and in a frontal pose). This is a reasonable assumption because it may be considered that the acquisition of the video of the person 40 which is being learned can be performed under well-controlled conditions. For each set of facial images (I₁^{(j)}, . . . I_{N}^{(j)}) extracted from a video sequence S^{(j)}, the following procedure is followed:
each image Iᵢ^{(j)} is resized 43 so that all the images have the same size: a set of images (I′₁^{(j)}, . . . I′_{N}^{(j)}) is then obtained;
a vector v′ᵢ^{(j)} is associated 44 with each of the resized facial images I′ᵢ^{(j)} extracted from the sequence S^{(j)}. The vector v′ᵢ^{(j)} is built by concatenation of the rows (or else of the columns) of the image I′ᵢ^{(j)}. Each component corresponds to the value of the grey level of a pixel of the image I′ᵢ^{(j)};
the vectors v′ᵢ^{(j)} are laid out 45 in the form of a matrix X^{(j)} in which each row corresponds to a vector v′ᵢ^{(j)} associated with an image I′ᵢ^{(j)};
a robust principal component analysis (RobPCA) 46 is applied to the matrix X^{(j)}. A new smaller-sized space is then defined by a robust projection matrix P^{(j)} and a robust mean μ^{(j)};
for a vector v′ᵢ^{(j)} (vector associated with a facial image of the person indexed j, row of the matrix X^{(j)}), two distances are computed 47: the orthogonal distance (DOᵢ^{(j)}) and the robust distance to the centre (DRCᵢ^{(j)}), in the following way:

$${Do}_{i}^{( j )} = ‖ {v}_{i}^{′ ( j )} - {μ}^{( j )} - {P}_{d , k}^{( j )} {y}_{i}^{t} ‖$$

$$and$$

$${DRC}_{i}^{( j )} = \sqrt{{\sum }_{m = 1}^{k} \frac{{y}_{im}^{2}}{{l}_{m}}} ,$$

where P^{(j)}_{d,k} is formed by the k first columns of P^{(j)}, and where yᵢ is the i^{th} row of the matrix Y^{(j)}, projection of the matrix X^{(j)} defined by Y_{n×k}=(X_{n×d}−1ₙμ′)P_{d×k}. the analysis of the distribution of the orthogonal distances and of the robust distances to the centre makes it possible to determine two decision thresholds DOₘₐₓ and DRCₘₐₓ, delivered at output of the RobPCA block 46. If for a vector v′ᵢ^{(j)}, DOᵢ^{(j)}>DOₘₐₓ^{(j)} or DRCᵢ^{(j)}>DRCₘₐₓ^{(j)} (48) then the vector v′ᵢ^{(j)}, is considered (49) to be an aberrant vector and the associated facial image is not selected (i.e. it is not taken into account during the learning). If not 50, the image Iᵢ^{(j)} is considered to be a representative facial image and is stored in the learning base BA 51;
the projection matrix P^{(j)}, the robust mean μ^{(j)} as well as the two decision thresholds DO^{(j)}ₘₐₓ and DRC^{(j)}ₘₐₓ for each sequence S^{(j)} are also saved in the learning base BA 51.

In one variant of an embodiment of this step of selection of the learning images representative of the face to be identified, simultaneous consideration is given to the set of facial images extracted from all the learning video sequences S^{(j)}. In this case, a single projection P, a single robust mean μ, a single decision threshold DOₘₐₓ and a single decision threshold DRCₘₐₓ are computed during the learning phase. The learning facial images are therefore filtered in using P, μ, DOₘₐₓ et DRCₘₐₓ. An image I′_{I} is filtered if:

DOᵢ>DOₘₐₓouDRCᵢ>DRCₘₐₓ

where DOᵢ and DRCᵢ are respectively the orthogonal distance and the robust distance to the centre of v′ᵢ (the vector associated with I′ᵢ) in using P and μ.

### 1.2 Building of the Description Space

Only the facial images selected 50 during the previous step are included in the learning base 51 used for the building of the description space. This space is computed by using one of the known statistical techniques such as the PCA (principal component analysis), LDA (linear discriminant analysis), 2DPCA or 2DLDA (i.e. two-dimensional PCA or LDA). The goal of these techniques is to find a space of reduced size in which the vectors vᵢ^{(j)} associated with the facial images are projected and compared.

Once the projection has been computed, all the vectors vᵢ^{(j)} associated with the facial images Iᵢ^{(j)} of the learning base 51 are projected in the description space. Their projections are then saved and used during the recognition phase.

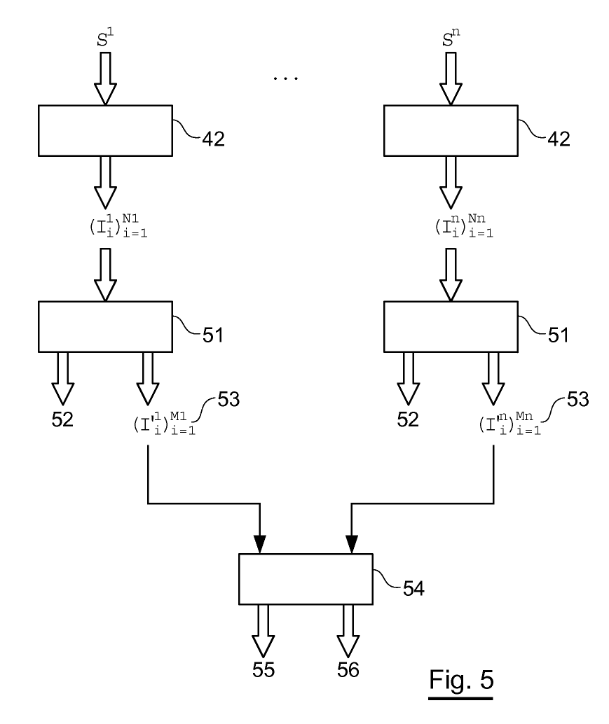

FIG. 5 presents a more schematic view of these two constituent phases of the learning phase, namely the analysis of the learning video sequences and the selection of the representative images (§1.1) and the building of the description space (§1.2). A plurality of learning video sequences S¹ to Sⁿ is available at input. These video sequences are generally each associated with a distinct person whom it is sought to identify. A face detector 42 is applied to each of these sequences in order to extract n sets of facial image (Iᵢ¹)ᵢ₌₁^{N1} to (Iᵢ^{N1})ᵢ₌₁^{Nn}. On each of these sets of facial images, a selection 51 is made of representative facial images, by which it is possible to obtain:
firstly, data 52 comprising the two filtering thresholds DOₘₐₓ and DRCₘₐₓ associated with the video sequence considered, and a projection method associated with the sequence (for example in the form of a projection matrix P and a robust mean μ associated with the images of the sequence);
secondly representative learning facial images (Iᵢ¹)ᵢ₌₁^{M1} to (Iᵢⁿ)ᵢ₌₁^{Mn} 53.

These learning images 53 representative of the faces to be identified are used to build 54 a description space 55, or model, associated with the persons to be identified, and to carry out the projection 56 of the vectors associated with the representative learning images 53.

Here below, we present the processing operations performed during the recognition phase of the identification method of an embodiment of the invention.

1.3 Selection of the Representative Images from the Query Sequence

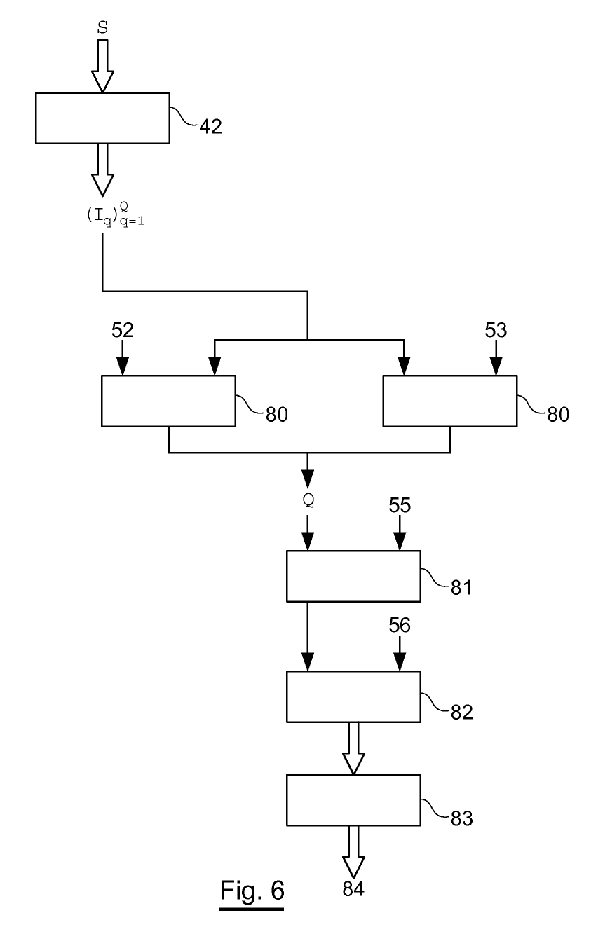

As illustrated in FIG. 6, in the presence of a query sequence S representing a person to be recognized (acquired for example by a video surveillance camera), all the facial images (I_{q})_{q=1}^{Q} are first of all extracted from the sequence S by means of an automatic face detector 42. Each of these images I_{q} may be considered to be a query image and may therefore serve to identify the person being sought. Now, just as during the learning phase, to increase the chances of properly identifying the person, it is chosen to select solely a subset of these images (I_{q})_{q=1}^{Q} for the identification. In a preferred embodiment of the invention, it is chosen not to reuse the same procedure as in the learning phase (§1.1), for the acquisition of the video query is done in conditions that are generally less well controlled (e.g. using a surveillance camera), and the assumption according to which the majority of the images extracted from the sequence are in frontal pose and well framed is not always verified.

In a sub-optimal variant of the invention, it is possible however to choose to carry out a processing operation, on the query images, that is identical to the one made on learning images during the learning phase, by RobPCA type analysis.

In the preferred embodiment of the invention, two variants can be envisaged, depending on whether the selection of the query images representative of the face to be identified is done on the basis of filtering thresholds DOₘₐₓ and DRCₘₐₓ computed during the learning, or directly from the representative learning images.

In a first variant, it is chosen to use the decision parameters 52 computed during the learning stage (§1.1, thresholds DOₘₐₓ and DRCₘₐₓ). A vector v_{q} is associated (by concatenation of the rows or else of the columns of the image) with each facial image I_{q} extracted from the query sequence S, and the following algorithm 80 is applied to decide to keep or not the facial image I_{q} and to use it not use it during the identification: For each of the video sequences S^{(j)} used during the learning:
load the projection matrix P^{(j)}, the robust mean μ^{(j)} as well as the two decision thresholds DOₘₐₓ^{(j)} and DRCₘₐₓ^{(j)} which had been saved during the learning phase,
compute the orthogonal distance DO_{q}^{(j)} and the robust distance to the centre DRC_{q}^{(j)} of v′_{q} (where v′_{q} is the vector associated with the image I′_{q} resulting from the resizing of I_{q} similar to the one done on the learning images and described here above in this document) in using P^{(j)} and μ^{(j)} as follows:

$${DO}_{q}^{( j )} = ‖ {v}_{q}^{( j )} - {μ}^{( j )} - {P}_{d , k}^{( j )} {y}_{i}^{t} ‖$$

$$and$$

$${DRC}_{q}^{( j )} = \sqrt{{\sum }_{m = 1}^{k} \frac{{y}_{im}^{2}}{{l}_{m}}} ,$$

where P^{(j)}_{d,k} is formed by the k first columns of P^{(j)}, and where yᵢ is the i^{th} row of the matrix Y^{(j)}, projection of the matrix X^{(j)} defined by Y_{n×k}=(X_{n×d}−1ₙm^{t})P_{d×k}.
   The image I_{q} is not selected if DO_{q}^{(j)}>DOₘₐₓ^{(j)} ou DRC_{q}^{(j)}>DRCₘₐₓ^{(j)}, ∀j. In other words, a facial image is not taken into account during the recognition if the associated vector is considered to be aberrant by all the projections and the thresholds computed for all the learning video sequences.

In the variant of an embodiment in which consideration is given, during the learning, to only one set in which all the learning images are grouped together, and in which only one projection P, only one robust mean μ only one decision threshold DOₘₐₓ and only one decision threshold DRCₘₐₓ, are computed, the facial query images are also filtered in using P, μ, DOₘₐₓ and DRCₘₐₓ during the recognition phase. As in the case of the learning, a query image I is filtered (i.e. considered to be aberrant) if:

DO_{q}>DOₘₐₓ ou DRC_{q}>DRCₘₐₓ

where DO_{q} and DRC_{q} are respectively the orthogonal distance and the robust distance to the centre of v′ (where v′ is the vector associated with I′, the image resulting from the resizing of I) in using P and μ.

A second variant uses the representative learning images 53 coming from the learning phase. With each facial image I_{q} extracted (42) from the query sequence S, a vector v_{q} is associated (by concatenation of the rows or else of the columns of the image) and this vector is inserted into each of the sets of vectors associated with the representative learning images 53 coming from the video sequences S^{(j)} used during the learning. There are thus as many sets available as there are learning sequences S^{(j)}. A filtering procedure is then applied to each of these sets. This filtering procedure is similar to the one used during the learning in computing the thresholds DOₘₐₓ and DRCₘₐₓ associated with each of these sets. The facial image I_{q} is selected 80 if it is chosen as being a representative image by at least one of the filtering procedures applied (i.e. if for at least one of the sets, we have DO_{q}≦DOₘₐₓ and DRC_{q}≦DRCₘₐₓ).

This procedure of selection 80 of the representative query images may also be applied by inserting one or more images I_{q} in the set of facial images made up of all the representative learning images coming from the learning phase (all learning sequences without distinction). However, it is desirable that the number of images I_{q} inserted should remain smaller than the number of representative learning images. The filtering procedure is thus executed only once and the facial image I_{q} is selected if it is chosen as a representative image. In this case, only two thresholds DOₘₐₓ and DRCₘₐₓ are computed for the set constituted by all the representative learning images and the image or images (s) I_{q}.

The set of facial images selected from the query sequence is noted as follows

Q=[q₁, q₂, . . . , qₛ]

### 1.4 Recognition

The identification of a query image qᵢ is done in two steps. First of all, the representative query image qᵢ is projected 81 in the description space 55 (computed during the learning) in the same way as the images of the learning base (step 54). Then, a search 82 is made for the closest neighbor in the description space 55. This involves searching for that projected vector among the projected vectors 56 corresponding to the images of the learning base which is the closest to the query projected vector. The query image qᵢ is assigned to the same person as the person associated with the closest retrieved neighbor. Each image qᵢ thus votes for a given person, i.e. designates a person among those stored in the learning base. Then, the results obtained for each of the representative query images of the set Q are merged 83, and the face of the query sequence is finally recognized 84 as the person who will have obtained the largest number of votes.

Other identification procedures on the basis of the images of the set Q may be applied.

### 1.5 Detailed Description of the Processing Operations Performed in the Context of an Embodiment of the Invention

Here below, a more detailed description is provided of the practical implementation of an embodiment of the invention, as well as the mathematical processing operations performed in the set of steps described here above in § 1.1 to 1.4.

It is assumed that there is a set of video sequences S⁽¹⁾, . . . , S^{(r)} available, each associated with one of the persons for whom the learning is being done. Each sequence is acquired for example by filming the associated person by means of a camera for a determined duration.

As presented in §1.1, from each learning sequence S^{(j)}, a set of facial images is extracted I₁, I₂, . . . , Iₙ by means of an automatic face detector applied to each of the images of the video sequence. The operation uses for example the CFF detector described by C. Garcia and M. Delakis in “Convolutional Face Finder: A Neural Architecture for Fast and Robust Face Detection”, IEEE Trans. on Pattern Analysis and Machine Intelligence, 26(11):1408-1423, November 2004. These images are then resized so that they all have the same size (28×31). This resolution makes it possible to avoid taking account of the details in the images for the only the pose of the face (whether frontal or not) and its positioning in the image matters.

A procedure for the selection of the representative learning images is then applied. This procedure starts with a robust principal component analysis (RobPCA) on the matrix X_{n×d} of the data, formed by vectors associated with the extracted facial images (d=28×31). The row j of the matrix corresponds to the vector associated with the image Iⱼ. This vector is built by concatenation of the rows of the image Iⱼ after resizing.

The RobPCA can be used to compute a robust mean μ (vector with dimension d) and a robust matrix of covariance C_{d×d} in considering only a subset of the vectors (namely vectors sized d associated with the facial images. Each vector corresponds to a row of the matrix X). It also enables the reduction of the size of the images by projecting them in a much smaller-sized space k (k<d) defined by the eigen vectors of the robust covariance matrix C. According to the principle of the RobCap, and as described in detail in appendix 1 which is an integral part of the present description, if:

C_{d×d}=PLP^{t} (1)

where P is the matrix of the eigen vectors and L is a diagonal matrix of the eigenvalues (L=diag (l₁, l₂, . . . , l_{d})), then the projection of the matrix X is given by:

Y_{n×k}=(X_{n×d}−1ₙμ′)P_{d×k}

where P_{d×k} is formed by the k first columns of P.
In the matrix Y, the row i represents the projection of the row i of the matrix X. It is therefore the projection of the image Iᵢ. The computation details of the matrix C and of the robust mean μ by the RobPCA are given in appendix 1 which forms an integral part of the present description.

To select the representative learning images (and therefore filter the noisy images) two distances are computed for each image Iᵢ: these are the orthogonal distance (DOᵢ) and the robust distance to the centre (DRCᵢ). These two distances are computed as follows:

$$\begin{matrix}{DO}_{i} = ‖ {x}_{i} - μ - {P}_{d , k} {y}_{i}^{t} ‖ , & ( 2 ) \\ {DRC}_{i} = \sqrt{{\sum }_{j = 1}^{k} \frac{{y}_{ij}^{2}}{{l}_{j}}} , & ( 3 )\end{matrix}$$

where xᵢ is the vector associated with Iᵢ (row i of the matrix X) and yᵢ is the i^{th} row of the matrix Y.

To isolate the aberrant vectors, the distributions of these two distances are studied. The threshold associated with the robust distance to the centre is defined by \sqrt{χ_{k,0.975}²} if k>1 and ±\sqrt{χ_{1,0.975}²} if k=1 (for the square distance of Mahalanobis on standard distributions approximately follows a χₖ² law) (see above-mentioned article by M. Hubert and al.). Let this threshold be written as DRCₘₐₓ^{(j)}, j being the number of the learning sequence. The threshold of the orthogonal distance is, on the contrary, more difficult to fix because the distribution of the values DOᵢ is not known. The method proposed in the article by M. Hubert and al. is used again for the computation of this threshold, i.e. the distribution is approximated by a g₁χ_{g}_{₂}² law, and the Wilson-Hilferty method is used for the estimation of g₁ and g₂. Thus, the orthogonal distance to the power ⅔ follows a normal distribution with a mean value

$$m = {( {g}_{1} , {g}_{2} )}^{1 / 3} ( 1 - \frac{2}{9 {g}_{2}} )$$

and variance

$${σ}^{2} = \frac{2 {g}^{2 / 3}}{9 {g}_{2}^{1 / 3}} .$$

In estimating the mean \hat{m} and the variance \hat{σ}² from the values DOᵢ by means of the MCD estimator (see article by M. Hubert and al.), the threshold associated with the orthogonal distance for the memory sequence j is given by: DRCₘₐₓ^{j}=(\hat{m}+\hat{σ}z_{0.975})^{3/2} where z_{0.975}=Φ⁻¹(0.975) is the quantile at 97.5% of a Gaussian distribution.

Representative facial images such as those of FIG. 1 are selected by means of the procedure presented herein, from a set of faces comprising images of the type shown in FIGS. 1 and 2. The proposed method therefore enables the selection of only frontal pose images (FIG. 1) and the isolation of profile faces or poorly framed faces (FIG. 2).

After selection of the representative learning images, the description space can be built by principal component analysis (PCA). In taking up the selected representative learning images, first of all a learning base is built in the form of a matrix. Each facial image is resized so that all the images have the same size. The chosen size is for example 63×57. The size may be the one obtained directly at output of the face detector. Each image then has an associated vector sized 63×57 built by concatenation of rows of the image. Each vector is then positioned in a row of the data matrix written as X_{m,d}, where m is the number of facial images selected and d the size of the vectors (in this case d=63×57).

It would be noted, that throughout the rest of this document, the notations used for the different variables are independent of the notations used hitherto in §1.5 of this document.

To compute the description space, X is first of all centered and a spectral decomposition is done:

X_{m,d}−1ₘμ^{t}=U_{m,d}D_{d,d}V_{d,d}^{t} (12)

where α is the mean of the vectors associated with the images of the selected faces (rows of the matrix X) and D is a diagonal matrix D=diag(l₁, l₂, . . . l_{d}).

The description space is defined by the vectors of the matrix V which are also the eigen vectors of the covariance matrix of X. The number of vectors chosen defines the dimension r of the description space. This number may be fixed by analyzing the eigenvalues (D) by the criterion of the proportion of the inertia expressed, i.e. such that:

$${\sum }_{j = 1}^{r} {l}_{j} / {\sum }_{j = 1}^{d} {l}_{j} = α , \qquad ( 13 )$$

where α is an a priori fixed parameter.
Thus, the vectors projected in the space of the description are defined by:

Y_{n,r}=(X_{m,d}−1ₘμ^{t})V_{d,r} (14)

Y, μ and V are saved for the recognition phase.

During the recognition phase, the query images representative of the face to be identified are selected from the query sequence following the procedure described in §1.3. Let these images be written as q₁, . . . , qₛ. These images are first of all resized so that they have the same size as the images used in the learning phase (63×57 in the above case). A vector is then associated with each of these images. Let these vectors be written as v₁, . . . , vₛ. Each vector is then projected into the description space as follows:

bᵢ=(vᵢ−μ)^{t}V_{d,r} (15)

For each projected vector bᵢ, the vector yᵢ (the i^{th} row of the matrix Y) which is closest to it is retrieved by computing the distance between bᵢ and all the vectors yᵢ. The facial image associated with bᵢ is therefore recognized as being the person associated with the image represented by the closest neighbor retrieved. It is said that bᵢ has voted for the person identified. Once this has been done for all the bᵢ, the face of the query sequence is finally recognized as being that of the person who has obtained the greatest number of votes.

### 1.6 Learning and Recognition Devices

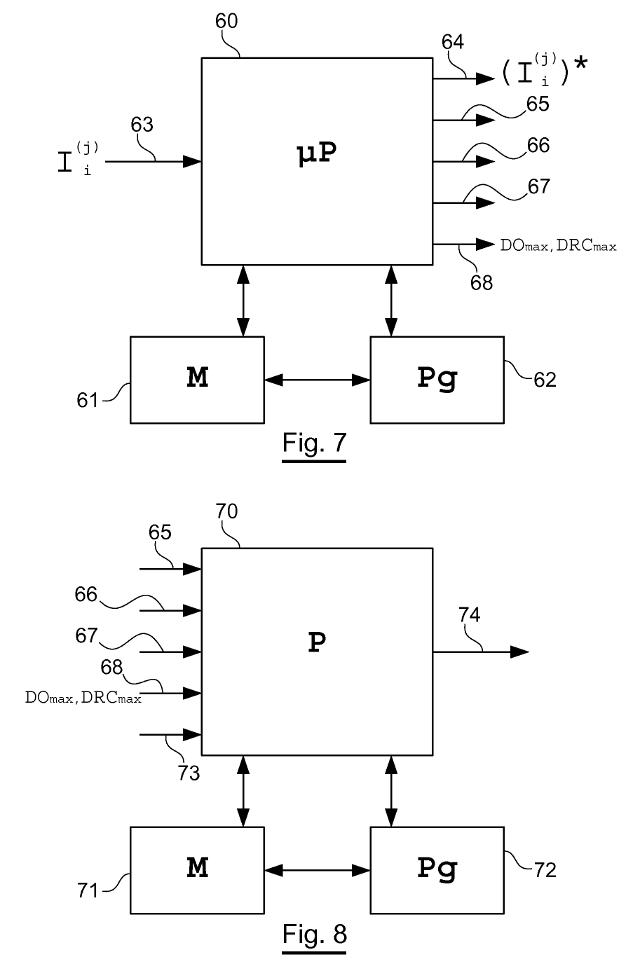

FIG. 7 finally presents a structure of a learning device of an embodiment of the invention, which comprises a memory M 61, and a processing unit 60 equipped with a processor μP that is driven by the computer program Pg 62. The processing unit 60 receives at input a set of learning facial images Iᵢ^{(j)} 63, associated with one or more persons identified by the index j, from which the microprocessor μP, working according to the instructions of the program Pg 62, performs a Robust Principal Component Analysis or RobPCA. From the results of this analysis, the processor μP of the processing unit 60 determines two thresholds 68 for filtering the images 63, called DOₘₐₓ and DRCₘₐₓ, either for each subset of images associated with each person having an index j, or for the set 63 of learning images. The data 68 also comprises a robust mean μ and a projection matrix P. Then, on the basis of these thresholds, the processor μP selects the mean μ and the projection matrix P and selects one or more representative learning images 64 of the face or faces to be identified (Iᵢ^{(j)})* from the set 63 of learning images 63, delivered at output of the processing unit 60. A PCA type analysis also enables the processor μP to determine a description space, or model 65 associated with each of the persons having an index j, as well as a method of projection 66, in this description space 65, of vectors associated with the learning images, in the form of a mean and a projection matrix. The processing unit 60 also delivers at output the projection 67 of the set of vectors associated with the representative learning images 64.

FIG. 8 illustrates a simplified scheme of a facial image recognition device comprising a memory M 71 and a processing unit 70 equipped with a processor μP, that is driven by the computer program Pg 72. The processing unit 70 receives the following at input:
a set of query facial images 73, from which the recognition device must identify the face of a person;
the filtering thresholds DOₘₐₓ and DRCₘₐₓ, as well as the robust mean μ and the projection matrix P 68 delivered at output of the learning device;
the description space 65 built by the learning device;
the projection method 66 used by the learning device;
the vectors 67 associated with the representative learning images and projected in the description space by the learning device.
   The processor μP of the processing unit 70, working according to the instructions of the program Pg 72, selects one or more representative query images of the face to be identified from among the set of query images 73 and using the thresholds DOₘₐₓ and DRCₘₐₓ, the robust mean μ and the projection matrix P 68. It then projects the vectors associated with these representative query images in the description space 65, in following the projection method 66. It then compares the projected learning vectors and the projected query vectors in order to determine which is the face 74 identified as being the one in the query images 73.

In the variant already mentioned here above, the thresholds 68 at input of the recognition device are replaced by the representative learning images 64, and the processor μP of the processing unit 70 performs a filtering identical to the one made by the learning device, from the set constituted by a query image 73 and the representative learning messages 64.

It will be noted that this description has focused on a technique implementing a RobPCA type analysis. Naturally, it would be equally possible to use any other filtering technique based on two thresholds similar to the thresholds DOₘₐₓ and DRCₘₐₓ.

An aspect of the disclosure provides a technique for the recognition of faces from still facial images or video sequences with improved performance as compared with prior art techniques. In particular, an aspect proposes a technique of this kind that gives satisfactory results even when the facial images to be processed are noisy, poorly framed and/or show poor lighting conditions.

An aspect of the disclosure proposes a technique of this kind that can be used to optimize the recognition capacities of the statistical methods on which they rely.

An aspect of the disclosure provides a technique of this kind that takes account of the quality of the facial images used.

An aspect of the disclosure proposes a technique of this kind that is well adapted to the recognition of several distinct persons, in the context of applications of biometrics, video surveillance and video indexing for example.

An aspect of the disclosure provides a technique of this kind that is simple and cost little to implement.

Although the present disclosure have been described with reference to one or more examples, workers skilled in the art will recognize that changes may be made in form and detail without departing from the spirit and scope of the disclosure and/or the appended claims.

### APPENDIX 1

### Computation of the Robust Mean μ and of the Robust Covariance Matrix C by the RobPCA

RobPCA can be used to perform principal component analysis, but in considering solely a subset of vectors. The idea is to avoid the inclusion, in the analysis, of noisy data which risks affecting the computation of the mean and the covariance matrix (first and second order moments which are known to be highly sensitive to noise). To this end, RobPCA is based on the following property: a subset A is less noisy than another subset B if the vectors of A are less dispersed than those of B. in statistical terms, the least noisy set being the one for which the determinant of the covariance matrix is the smallest.

Take a set of n vectors sized d arranged in the form of a matrix X_{n,d}. RobPCA is performed in four steps:

1. The data of the learning base (BA) is pre-processed by means of a classic PCA (Principal Component Analysis). The aim is not to reduce their size because all the main components are kept. What is done simply is to eliminate the superfluous sizes. To this end, a decomposition into singular values is done:

X_{n,d}−1ₙm₀^{t}=U_{n,t}_{₀}Dᵣ_{₀}_{,r}_{₀}Vᵣ_{₀}_{,d}^{t},

where m₀ is a classic mean and r₀ the rank of the matrix X_{n,d}−1ₙm₀^{t}.

The data matrix X is then transformed as follows:

Z_{n,r}_{₀}=UD.

It is the matrix Z that is used in the following steps. Here below, the matrix Z is considered to be a set of vectors where each vector corresponds to a row of the matrix and is associated with one of the facial images extracted from a sequence.

2. The aim of the second step is to retrieve the h least noisy vectors. It may be recalled that a vector refers here to a row of the matrix Z, corresponds to a facial image and is written as zᵢ.

The value of h could be chosen by the user but n−h must be greater than the total number of aberrant vectors. Since the number of aberrant vectors is generally unknown, h is chosen as follows:

h=max{[αn],[(n+kₘₐₓ+1)/2]}, (4)

where kₘₐₓ is the maximum number of principal components that will be chosen and α is parameter ranging from 0.5 to 1. It represents the proportion of the non-noisy vectors. In the present case, this parameter corresponds to the proportion of the learning facial images extracted from a sequence that are of good quality and could be included in the learning base. The value of this parameter could therefore be fixed as a function of the conditions of acquisition of the learning sequences and the quality of the facial images extracted from the sequences. The default value is 0.75.

The following is the method used to find the h least noisy vectors:

First of all a computation is made, for each vector zᵢ, of its degree of noisiness defined by:

$$outl ( {z}_{i} ) = {max}_{v ∈ B} \frac{\vert {z}_{i}^{t} v - {t}_{MCD} ( {z}_{j}^{t} v ) \vert}{{s}_{MCD} ( {z}_{j}^{t} v )} , \qquad ( 5 )$$

where B is the set of all the directions passing through two different vectors. If the number of directions is greater than 250, a subset of 250 directions is chosen randomly. t_{MCD}(zⱼ^{t}v) and s_{MCD}(zⱼ^{t}v) are respectively the robust mean and the robust standard deviation of the projection of all the vectors along the direction defined by v. this is the mean and standard deviation of the h projected values having the smallest variance. These two values are computed by the one-dimensional MCD estimator described by Hubert and al. in the above-mentioned article.

If all the s_{MCD} are greater than zero, the degree of noisiness outl is computed for all the vectors, and the h vectors having the smallest values of the degree of noisiness are considered. The indices of these vectors are stored in the set H₀.

If along one of the directions, s_{MCD}(zⱼ^{t}v) is zero, it means that there is a hyperplane Hᵥ orthogonal to v which contains h vectors. In this case, all the vectors are projected on Hᵥ, which has the effect of reducing the size of the vectors to one, and the computation of the degrees of noisiness is resumed. It must be noted here that this can possibly occur several times.

At the end of this step, there is a set H₀ of the least noisy vectors and, as the case may be, a new set of data Z_{n,r}_{₁} with r₁≦r₀.

Then, the mean m₁ and a covariance matrix S₀ of the h vectors previously selected are considered to perform a principal component analysis and reduce the size of the vectors. The matrix S₀ is broken down as follows: S₀=P₀L₀P₀^{t} with L₀ as the diagonal matrix of the eigenvalues: L₀=diag(\tilde{l}₀ . . . \tilde{l}ᵣ) and r≦r₁. All the \tilde{l}ⱼ are deemed to be non-null and to be set in descending order. This decomposition makes it possible to decide on the number of principal components k₀ to be kept for the remainder of the analysis. This can be done in different ways. For example, k₀ could be chosen such that:

$${\sum }_{j = 1}^{{k}_{0}} {\tilde{l}}_{j} / {\sum }_{j = 1}^{r} {\tilde{l}}_{j} = 90 \% , \qquad ( 6 )$$

Or else such that:

\tilde{l}ₖ/\tilde{l}₁≧10⁻³. (7)

Finally, the vectors are projected in the space defined by the k₀ first eigen vectors of S₀. The new matrix of vectors is given by:

Z_{n,k}_{₀}*=(Z_{n,r1}−1ₙm₁^{t})P₀₍ᵣ_{₁}_{,k}_{₀}₎, where P₀₍ᵣ_{₁}_{,k}_{₀}₎ is formed by the k₀ first columns of P₀.

3. In the third step, the covariance matrix of the vectors of Z_{n,k}_{₀}* is estimated by means of an MCD estimator. The idea is to retrieve the h vectors whose covariance matrix has the smallest determinant. Since it is practically impossible to compute the covariance matrices of all the subsets containing h vectors, an approximate of algorithm is used. This algorithm works in four steps.

3.1 Let m₀ and C₀ be respectively the mean and the covariance matrix of h vectors selected in the step 2 (set H₀):
(a) If det(C₀)>0 then compute for each vector zᵢ*, the Mahalanobis distance relative to m₀:

dₘ_{₀}_{,C}_{₀}(i)={square root over ((zᵢ*−m₀)^{t}C₀⁻¹−m₀))} (8)
The selection of the h vectors with the smallest distances dₘ_{₀}_{C}_{₀} (i) enables the building of a new set H₁ for which the determinant of the covariance matrix is smaller than the determinant of C₀. In other words, if m₁ and C₁ are respectively the mean and the covariance matrix of the h vectors of H₁ then det(C1)≦det(C0).

This procedure, called C-Step, is therefore executed iteratively until the determinant of the covariance matrix of the h selected vectors no longer decreases.
(b) If, at a given iteration j, the covariance matrix Cⱼ is singular, then the data is projected in the smallest-sized space defined by the eigen vectors of Cⱼ whose eigenvalues are non-null, and the procedure continues.

At convergence, we obtain a data matrix which will be written as Z_{n*k}_{₁}* with k₁≦k₀ and a set H₁ containing the indices of the h vectors that have been selected during the last iteration. Let m₂ and S₂ respectively denote the mean and the covariance matrix of these h vectors.

3.2 The algorithm FAST-MCD proposed by Rousseeuw and Van Driessen in 1999 and slightly modified is applied to the matrix Z_{n*k}_{₁}*. The version of this algorithm used randomly draws 250 subsets sized (k₁+1). For each, it computes the mean, the covariance matrix and the Mahalanobis distances (equation 8) and completes the subset by the vectors having the smallest distances to have a subset containing h vectors. It then applies the C-Step procedure to refine the subsets. It may be noted here that, in a first stage, only two C-Step iterations are applied to each of the 250 subsets. The 10 best subsets (the sets having the smallest determinants of their covariance matrices) are then selected and the iterative procedure (a) and (b) of 3.1 is applied to them until convergence.

Let us write \tilde{Z}_{n,k}* with k≦k₁ the set of data obtained at the end of the application of the FAST-MCD algorithm and m₃ and S₃ the mean of the covariance matrix of the h vectors selected. If det(S₂)<det(S₃) then the computation is continued in considering the h vectors obtained from the step 3.1, i.e. m₄=m₂ and S₄=S₂, else, the results obtained by FAST-MCD, i.e. m₄=m₃ and S₄=S₃, are considered.

3.3. In order to increase statistical efficiency, a weighted mean and a weighted covariance matrix are computed from m₄ and S₄. First of all, S₄ is multiplied by a consistency factor c₁ computed as follows

$${c}_{1} = \frac{{\{ {d}_{{m}_{4} , {S}_{4}}^{2} \}}_{( h )}}{{χ}_{k , \frac{h}{n}}^{2}} \qquad ( 9 )$$

where {dₘ_{₄}_{,S}_{₄}²}₍₁₎≦ . . . ≦{dₘ_{₄}_{,S}_{₄}²}₍ₙ₎ and are computed in using the vectors of according to the equation (8). Then the Mahalanobis distances of all the vectors of \tilde{Z}_{n,k}* are computed in using m₄ and c₁S₄. Let these distances be written as: d₁, d₂, . . . , dₙ. The mean and the covariance matrix are finally estimated as follows:

$$\begin{matrix}{m}_{5} = \frac{{\sum }_{i = 1}^{n} {w}_{i} {\tilde{z}}_{i}^{*}}{{\sum }_{i = 1}^{n} {w}_{i}} \\ and & ( 10 ) \\ {S}_{5} = \frac{{\sum }_{i = 1}^{n} {w}_{i} ( {\tilde{z}}_{i}^{*} - {m}_{5} ) {( {\tilde{z}}_{i}^{*} - {m}_{5} )}^{t}}{{\sum }_{i = 1}^{n} {w}_{i} - 1} \\ where {w}_{i} = w ( {d}_{i} ) = \{ \begin{matrix}0 & {sid}_{i} \leq \sqrt{{χ}_{k , 0 , 975}^{2}} \\ 1 & {sid}_{i} > \sqrt{{χ}_{k , 0 , 975}^{2}}\end{matrix} & ( 11 )\end{matrix}$$

4. The purpose of this last step is to deduce the final mean and covariance matrix. First of all, a spectral decomposition of the covariance matrix S₅ is performed:

S₅=P₂L₂P₂^{t}

where P₂ is a matrix k×k that contains the eigen vectors of S₅ and L₂ a diagonal matrix with the corresponding eigenvalues.

The matrix P₂ is then projected in [symbol] by applying the inverse transforms of those applied throughout the preceding steps. This gives the final matrix of the eigen vectors P_{d,k}. Similarly for the mean: m₅ is projected in [symbol] thus giving μ. Furthermore, the final covariance matrix C could be computed by means of the equation (1).

1-15. (canceled)

16. Method of identification of at least one face from a group of at least two facial images associated with at least one person, said method comprising a phase of learning and a phase of recognition of said at least one face, wherein:
said learning phase comprises at least one first step of filtering said images, using a group of at least two learning facial images associated with said at least one person, enabling the selection of at least one learning image representing said face to be identified,
said recognition phase using solely said learning images selected during said learning phase, and
said filtering is done using at least one of the thresholds belonging to the group comprising:
a maximum distance (DRCₘₐₓ) taking at least account of the membership of vectors associated with at least certain of said images in a cloud constituted by said vectors;
a maximum distance (DOₘₐₓ) between said vectors and vectors rebuilt after projection of said vectors on a space associated with said cloud of vectors.

17. Method of identification according to claim 16, wherein at least one of said thresholds is determined from vectors associated with said learning images.

18. Method of identification according to claim 16, wherein said learning phase comprises a step of building a vector space of description of said at least one person from said representative learning image or images.

19. Method of identification according to claim 16, wherein said recognition phase implements a second filtering step from a group of at least two facial images associated with said at least one person, called query images, and enables the selection of at least one query image representing said face to be identified, and in that at least one of said thresholds is determined during said learning phase, from vectors associated with learning facial images.

20. Method of identification according to claim 16, wherein at least one of said thresholds is determined during said recognition phase, using vectors associated with a set of images comprising at least two facial images associated with said at least one person, called query images and at least two learning images representing said face to be identified, selected during said learning phase, and said recognition phase implements a second filtering step, using said query images, and enables the selection of at least one query image representative of said face to be identified.

21. Method of identification according to claim 19, wherein said recognition phase also includes a step of comparison of projections, in a vector space of description of said at least one person built during said learning phase, of vectors associated with said at least one representative query image and with at least one representative learning image selected during said learning phase so as to identify said face.

22. Method of identification according to claim 20, wherein said recognition phase also includes a step of comparison of projections, in a vector space of description of said at least one person built during said learning phase, of vectors associated with said at least one representative query image and with at least one representative learning image selected during said learning phase so as to identify said face.

23. Method of identification according to claim 16, wherein said at least one of first step of filtering apply said two thresholds.

24. Method of identification according to claim 19, wherein said second step of filtering said query images apply said two thresholds.

25. Method of identification according to claim 20, wherein said second step of filtering said query images apply said two thresholds.

26. Method of identification according to claim 19, wherein said learning phase being implemented for learning images associated with at least two persons, one determines said thresholds associated with the learning images of the set of said at least two persons, and wherein, during said recognition phase, said query images are filtered from said threshold associated with the set of said at least two persons.

27. Method of identification according to claim 16, wherein said thresholds are determined after a Robust Principal Component Analysis (RobPCA) applied to said vectors associated with said learning images, enabling the determining also of a robust mean p associated with said vectors, and a projection matrix P built from eigen vectors of a robust covariance matrix associated with said vectors,
and wherein said thresholds are associated with the following distances:
$${DO}_{i} = ‖ {x}_{i} - μ - {P}_{d , k} {y}_{i}^{t} ‖$$
$${DRC}_{i} = \sqrt{{\sum }_{j = 1}^{k} \frac{{y}_{ij}^{2}}{{l}_{j}}}$$
where
xᵢ is one of said vectors associated with said learning images,
P_{d,k} is the matrix comprising the k first columns of said projection matrix P,
yᵢⱼ is the j^{th} element of a projection yᵢ of said vector xᵢ from said projection matrix and from said robust mean.

28. Learning method for the identification of at least one face, from a group of at least two learning facial images associated with at least one person, wherein the learning method implements:
a step of analysis of said learning images that makes it possible, using vectors associated with said learning images, to determine at least one of the thresholds belonging to the group comprising:
a maximum distance (DRCₘₐₓ) taking at least account of the membership of said vectors in a cloud constituted by said vectors;
a maximum distance (DOₘₐₓ) between said vectors and vectors rebuilt after projection of said vectors on a space associated with said cloud of vectors;
a first step of filtering said learning images, using at least one of said thresholds, so as to select at least one learning image representing said face to be identified;
a step of building a vector space of description of said at least one person from said representative learning image or images of said face to be identified;
so that only said learning images selected during said first filtering step are used during a step of recognition of at least one face.

29. Learning device of a system for the identification of at least one face from a group of at least two facial images associated with at least one person, wherein the learning device comprises:
means of analysis of said learning images that make it possible, using vectors associated with said learning images, to determine at least one of the thresholds belonging to the group comprising:
a maximum distance (DRCₘₐₓ) taking at least account of the membership of said vectors in a cloud constituted by said vectors;
a maximum distance (DOₘₐₓ) between said vectors and vectors rebuilt after projection of said vectors on a space associated with said cloud of vectors;
first means of filtering said learning images, using at least one of said thresholds, so as to select at least one learning image representing said face to be identified;
means of building a vector space of description of said at least one person from said learning image or images representing said face to be identified;
so that only said learning images selected by said learning device are used by a recognition device.

30. Device for the recognition of at least one face from a group of at least two facial images associated with at least one person, called query images, said recognition device belonging to a system of identification of said at least one face also comprising a learning device, wherein said recognition device comprises:
second means of filtering said query images, using at least one threshold determined by said learning device, so as to select at least one query image representing said face to be recognized;
means of comparison of projections, in a vector space of description of said at least one person built by said learning device, of vectors associated with said at least one representative query image and with at least one representative learning image selected by said learning device, so as to identify said face;
said learning device comprising first filtering means implemented from a group of at least two learning facial images associated with said at least one person enabling the selection of at least one representative learning image of said face to be identified,
said recognition device using only said learning images selected by said learning device.

31. Computer program stored on a computer readable memory and comprising program code instructions for the execution of the following method when said program is executed by a processor for identification of at least one face from a group of at least two facial images associated with at least one person, said method comprising a phase of learning and a phase of recognition of said at least one face, wherein:
said learning phase comprises at least one first step of filtering said images, using a group of at least two learning facial images associated with said at least one person, enabling the selection of at least one learning image representing said face to be identified,
said recognition phase using solely said learning images selected during said learning phase, and
said filtering is done using at least one of the thresholds belonging to the group comprising:
a maximum distance (DRCₘₐₓ) taking at least account of the membership of vectors associated with at least certain of said images in a cloud constituted by said vectors;
a maximum distance (DOₘₐₓ) between said vectors and vectors rebuilt after projection of said vectors on a space associated with said cloud of vectors.
